(19) United States
(12) Patent Application Publication
(10) Pub. No.: US 2007/0067590 A1
(43) Pub. Date: Mar. 22, 2007

(54) Providing protected access to critical memory regions

(76) Inventors: Uday Savagaonkar, Beaverton, OR (US); Priya Rajagopal, Worcester, MA (US); Ravi Sahita, Beaverton, OR (US); Hormuzd Khosravi, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/233,664

(22) Filed: Sep. 22, 2005

(51) Int. Cl. G06F 12/14

(52) U.S. Cl. 711/163

(57) ABSTRACT

Registering a first program operable to access a first address of a first protected region of memory in a registry and in response to a second program making a request to access a second address of a second protected region of memory, deciding whether the second program is registered in the registry; if the second program is registered, translating the second address to a physical address; checking the validity of a control register associated with a page table and if the control register is valid, relaxing a restriction on access to a field in a page table associated with the second address.

### CROSS-REFERENCE TO RELATED APPLICATION

The present application is related to pending U.S. patent applications Ser. No. 10/881,777 entitled “SYSTEM AND METHOD FOR SECURE INTER-PLATFORM AND INTRA-PLATFORM COMMUNICATIONS,” Attorney Docket Number P20148, and Ser. No. 11/173,851 entitled “SIGNED MANIFEST FOR RUN-TIME VERIFICATION OF SOFTWARE PROGRAM IDENTITY AND INTEGRITY,” Attorney Docket Number P21350, each referenced application assigned to the assignee of the present invention.

### BACKGROUND

Virtual and paged memory management systems are well known and are used in many processor based systems including, for example, systems based on an Intel® Architecture processor as described in the IA-32 Intel Architecture Software Developer's Manual, Vol. 3: System Programming Guide (IA-32 documentation). Generally, a virtual memory system presents a program executing on such a system with a logical, linear view of memory termed virtual memory. When the program accesses a location based on this view, the address it uses is termed a virtual address. This access is performed by the system after the virtual address is translated into a physical address which references the actual memory location at which the access occurs, by the operating system and system hardware. Furthermore, both virtual and physical memory is generally managed in logical units termed pages. Thus, a reference to a virtual memory location on a virtual page by a program is generally translated by the memory management system to a reference to physical memory location on a page of physical memory.

Generally, the control and management of a virtual, paged memory management system involves the use of control registers such as the GDTR, LTR, and CR3 registers in the IA-32 instance (further described in the IA-32 documentation), or their equivalents in other systems, and the use of one or more page tables resident in the random access memory (RAM) of the processor based system. A page table is generally a hierarchical structure that maps a program-linear view or a virtual address to a physical address on a page in physical memory on the system.

In most processor based systems, any system software or program executing in a privileged mode, such as for example in “ring 0” in a Linux system, may modify both the memory management control registers and the page tables. As is known, undesired software or malware such as a Trojan, worm, virus etc. may be able to breach the security of an operating system and obtain the privileges of a process executing in ring 0 or in a privileged mode. Thus, malware running as a privileged process may be able to damage running system processes by modifying their page tables or the memory management control registers despite the restrictions on access to such tables or registers. For example, malware may cause a system process to execute malware code by rewriting the page tables of the system process to cause it to reference malware code. Though chipset-based memory protection methods that monitor memory accesses may protect page tables in memory to some extent, if a process is able to breach the user-system barrier in most operating systems and operate as a privileged process, there is little that is known that may be done to prevent attacks on the control registers of the memory management system.

Processors such as Intel Processors and others may support a system management (SM) mode (SMM). A processor operating in SMM provides a special-purpose, alternate operating environment that can be used to monitor and manage various system-wide functions such as managing system resources for more efficient energy usage, to control system hardware, or to run specialized code outside the control of the normal operating environment such as the operating system.

When SMM is invoked, often through a system management interrupt (SMI), the processor switches to the separate operating environment and executes handler code to perform system management operations. Generally, code and data related to system management mode reside in a special area of memory that is inaccessible to processes such as the operating system when the system is executing in a non-SM mode, termed system management random access memory (SMRAM) in the IA-32 architecture. When the SMI handler has completed its operations, it resumes executing the interrupted application or operating-system program or task.

### BRIEF DESCRIPTION OF THE DRAWINGS

FIG. 1 depicts the organization of a page management system in one embodiment.

FIG. 2 depicts the organization of one embodiment at a block level.

FIG. 3 depicts processing in one embodiment.

FIG. 4 depicts processing in one embodiment.

FIG. 5 depicts a virtualization environment in one embodiment.

### DETAILED DESCRIPTION

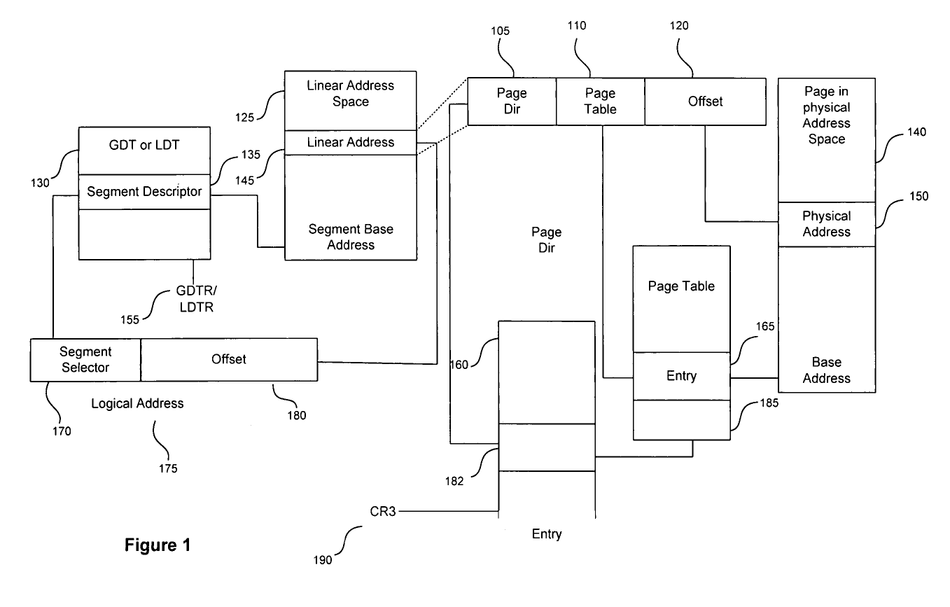

FIG. 1 depicts a segmented and paged virtual memory system in one embodiment. This instance is described in detail in the IA-32 documentation (IA-32 Intel Architecture Software Developer's Manual, Vol. 3: System Programming Guide, Chapter 3), however, salient details are provided herein for clarity. In this instance, an IA-32 memory management scheme maps a logical address 175 used by a process executing on an Intel Architecture IA-32 system to a physical address 150. The mapping uses a descriptor table register in the processor that specifies a descriptor table base address. This register may be a Global or a Local Descriptor Table Register (GDTR or LDTR) 155. The register references the corresponding descriptor table (Global Descriptor Table or GDT, or Local Descriptor Table, or LDT) in memory, 130. The logical address 175 includes a segment selector 170 and an offset 180. The segment selector serves as an index into the GDT or LDT 130 and references a segment descriptor 135, which in turn references the base address of a logical segment 125 in a logical view of memory. The offset is used to compute the actual linear memory location 145 which the process may access in its view of memory. This logical segmented address is a virtual address which is then mapped to a physical address by a page table system. The system in this example consists of a page directory 160, located in system memory, a page table 185, also in system memory, and a control register (CR) CR3, 190 located in the processor that references the page directory. The linear address is then used as follows: first, a page directory reference is computed from a field 105 of the linear address 145 to reference an entry in the page directory 182. This entry in turn refers to the base address of a page table 185 that corresponds to a page 140 in physical memory. The actual page address is then computed using a second field 110 of the linear address 145, the page table field, by using the field as an index into the page table. Finally, the offset field 120 from the linear address is added to the base address of the physical memory page 140 to obtain the final value of the memory address.

Of course, many other embodiments with different paging and virtual memory schemes are possible, as is well known. For instance, in other embodiments, there may be no segmentation table, and thus the use of segment selector 170, descriptor table 130, and registers 155 may not be required. In other embodiments, a hierarchical segmentation scheme may be used, requiring multiple levels of descriptor tables. Many variations are possible. Furthermore, the page table structure shown in FIG. 1 is hierarchical with a two level hierarchy, first a page directory 160 and then a page table 185. In other embodiments, different structures may be employed to implement a page table including a flat page table with no hierarchy, thus obviating the need for field 105, and directory 160. In such a scheme, the register referencing the page table may refer directly to the base address of a page table like 185. In other schemes, multiple levels of hierarchy may be used to implement a paging scheme. Furthermore, this scheme is independent of the word and field sizes used to implement the various fields and registers. These fields and registers may be 32 bit, 64 bit, or any other size based on a specific architecture of implementation. Even within a 32 bit or 64 bit architecture, different implementations may use different word, field, and register sizes as is known in the art. Many other variations are possible.

As may be seen from the Figure and the above description, the paged virtual memory system in the IA-32 embodiment and others involves several processor registers, and tables and fields in memory. In a typical architecture, access to these registers and fields is only available to processes or programs executing in a privileged mode, such as kernel drivers in an operating system, and thus they may be protected from access by normal user processes. However, the increasing occurrence of malware such as viruses, worms, Trojans, etc. that are able to violate the user-system barrier and acquire privileged mode access makes it possible that malware may damage or compromise a system by overwriting either a page table entry or a page table management register such as the ones discussed above. For example, a malicious process may alter the page table of an operating system driver to cause it to execute malware code instead of its own code, or cause system malfunctions by corrupting page tables in memory or memory management registers in the processor.

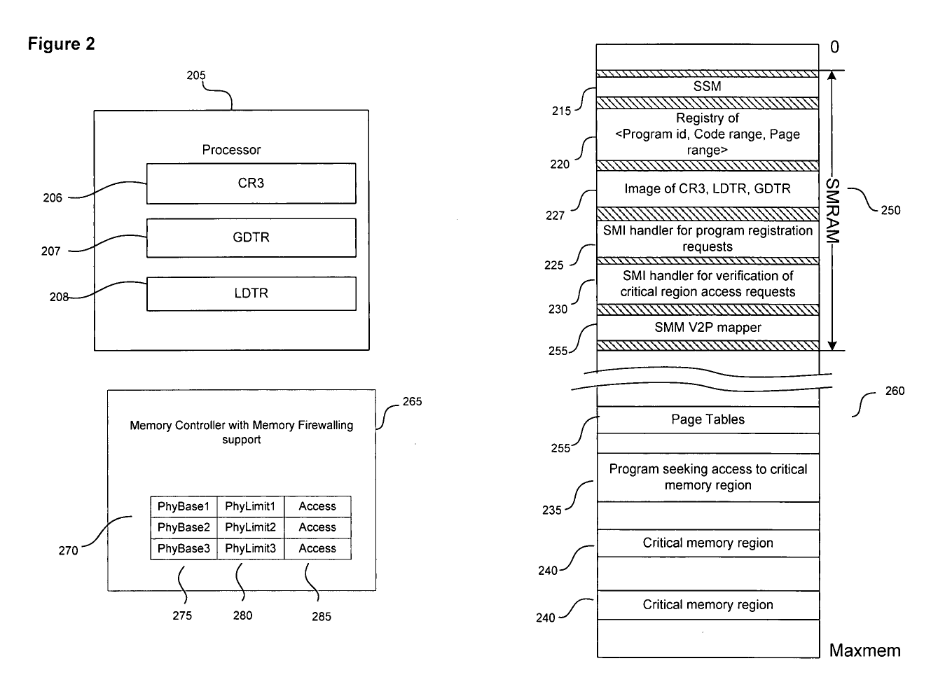

FIG. 2 depicts one embodiment, including a processor 205, a memory 260, and a memory controller with support for memory protection and monitoring in the controller, 265. The memory has a range of physical addresses ranging from locations 0 to Maxmem. The processor in this embodiment is an IA-32 processor that supports memory typing. In particular, the processor includes a set of page table control registers, the register CR3 106, and the GDTR and LDTR registers 207 and 208 respectively, among other registers and fields, to specify and control the segmented and paged virtual memory system. Memory controller 265 may be implemented as a separate module or chipset, or as a sub-component of the processor. In addition to typical functionality provided by a memory controller, this controller provides the ability to set access restrictions on ranges of memory using a table of access filters 270 that is accessible to a program executing on the system. Each entry in the access filter table 270 in this embodiment includes a base and limit address such as 275 and 280, respectively, and a set of access restrictions 285 for the memory locations ranging from the base to the limit address. The access restrictions may for example specify that a memory location is either read-only, or read-write only, or may be open to read, write and execute actions.

In addition, the processor 205 also supports a system management mode (SMM). When SMM is invoked through a system management interrupt (SMI), the processor saves the current state of the processor (the processor's context), then switches to a separate operating environment contained in system management RAM (SMRAM) 250. While in SMM, the processor may execute SMI handler code such as handlers 225 and 230 which also reside in SMRAM 250, to perform operations such as powering down unused disk drives or monitors, executing proprietary code, or placing the whole system in a suspended state. When the SMI handler has completed its operations, it executes a resume (RSM) instruction. This instruction causes the processor to reload the saved context of the processor, switch back to protected or real mode, and resume executing the interrupted application or operating-system program or task.

The following SMM mechanisms make SMM transparent to applications programs and operating systems:
The only way to enter SMM is by means of an SMI.
The processor executes SMM code in a separate address space (SMRAM) that can be made inaccessible from the other operating modes.
Upon entering SMM, the processor saves the context of the interrupted program or task within the System Saved Map (SSM) in SMRAM
All interrupts normally handled by the operating system are disabled upon entry into SMM.
The RSM instruction can be executed only in SMM.

Detailed description of the SMM mode in general may be found in the IA-32 documentation (IA-32 Intel Architecture Software Developer's Manual, Vol. 3: System Programming Guide, Ch. 13).

Of course, as will be appreciated by one of ordinary skill in the art, many variations on the above described example of system management in the IA-32 case are possible. For example, in other cases, the specific operations that trigger a system management event may differ. Furthermore, processors may have modes that differ from the set of modes in which an IA-32 processor implementing SMM may operate. The terms interrupt and resume are used here, but similar concepts may be expressed in other terminology, for example, a transfer of control to management mode may be termed a trap; and a resume may also be called a return or exit. The locations of objects in memory depicted in FIG. 2 are merely illustrative. In other embodiments, the relative locations of the various components of the system management memory partition may differ. The location of the system management memory partition itself may vary relative to other objects in the system memory viewed as a whole. For example, in the Figure, the base of SMRAM 250 is shown at a lower memory location than that of the program 235 seeking to modify memory type In other embodiments, it may be at a higher location. Of course, the sizes of the blocks of memory drawn in FIG. two are not intended to be to any scale, but are merely illustrative. A program may have two or more critical memory regions, or may not have any. Many other variations are possible.

As the Figure further illustrates, the SMM mode and other components of this embodiment may also be used to protect undesired modification of the registers and memory locations of the memory management system

A program 235 executing in privileged mode may be registered in a registry 220 that includes, for example its process identifier, and a code and memory page range for the program. Generally, the program 235 is a kernel mode or privileged operating system code such as a driver executing at the highest level of privilege available, and therefore able to modify the page table control registers 206-208 or other registers relating to memory management, and to modify page tables 255. A call or generated interrupt to a special SMM registration handler 225 may be used to register the program. The handler and the registry are stored in the system management memory (SMRAM) 250. Additionally, a shadow copy of the paging system registers may also be preserved in SMRAM at 227. As will be explained in detail subsequently, a program such as 235 at the time of registration also specifies a memory range corresponding to page table entries relating to its critical data that are to be protected by the memory controller 265. During registration, the handler 225 sets up controller 265 using access filters 270 to protect the appropriate portions of page tables 255 for the registered program 235. In the case of an agent such as an operating system driver, the portions of the page tables may include entries that are owned by other processes executing on the host that the operating system driver is authorized to modify. When the program later must modify the previously protected page table entries, it invokes second SMM mode agent or SMI handler 230 that is also part of SMRAM. This handler operates to service such interrupts, first to validate that the interrupting process such as the one at 235, is properly registered in the registry 220, to check the integrity of memory management registers, and then to relax access restrictions in memory controller 265 to provide access to the page tables in memory.

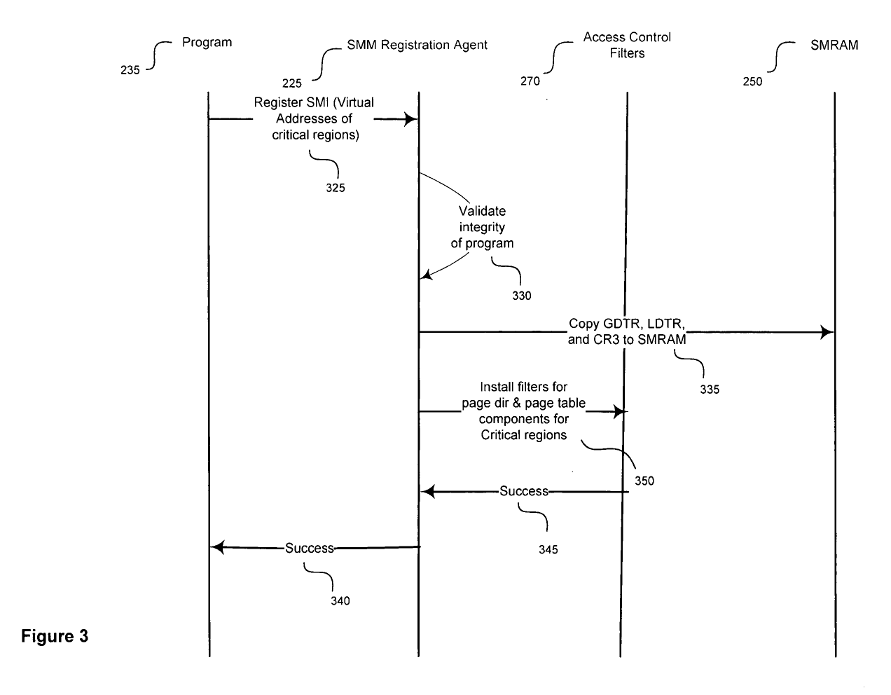

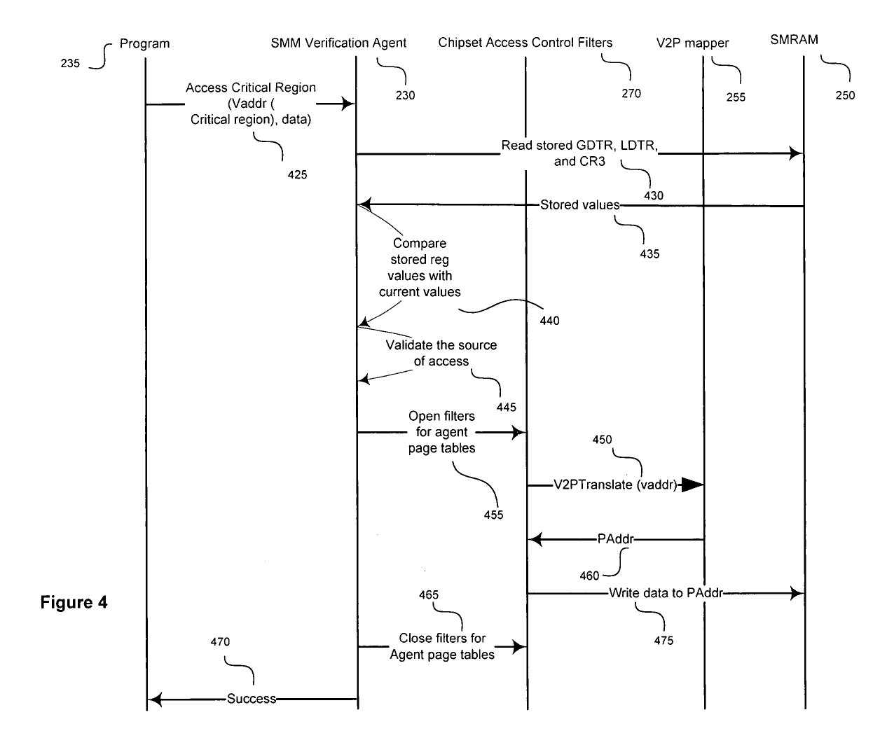

A more detailed view of the processing in this embodiment outlined with reference to FIG. 2 is provided in FIGS. 3 and 4.

In FIG. 3 an event diagram or concurrent flowchart for the registration process is provided. The event timelines in the Figure represent events occurring in the registrant program 235, the SMM registration and verification agent 225, the memory controller with access control filters 270, and in SMRAM, 250. When the registrant program 235 seeks to register and protect its critical regions, it generates an SMI to activate the SMM agent 225, at 325. It passes the virtual addresses of the critical regions in memory that it will be using in its processing. Before registering the program, the SMM agent may validate the integrity of the registrant at 330, for example, by measuring the program and comparing the measurement to a previously recorded value. This may be done in one embodiment by computing a hash of the code of the registrant program and comparing it to a previously stored “golden” value. If the validation fails, the registering agent 225 may exit.

Once the registrant is validated, the SMM agent then stores 335 the current values of the paging system control registers corresponding to the registrant in SMRAM, e.g. the values of GDTR, LDTR and CR3. Next, the SMM agent determines the page directory and page table locations that corresponding to the critical regions of the registering program, and instructs the memory controller to update its filter tables accordingly, example to restrict all write accesses to these page tables, 350. Once all operations have completed successfully, 345 and 340, the registrant has completed registration and may proceed.

At some point in its execution, the registered program may have to modify the protected regions of the page directory or the page tables. The processing to access these entries is depicted in FIG. 4. In the Figure, event timelines are provided for the registered program 235, SMM verification agent 230, the access control filters 270, V2P mapper 255 and SMRAM 250. Processing begins when program 235 triggers a special SMI to request access to the protected regions of memory. It passes the virtual address to the handler, and data to be stored at that address. The handler first verifies the integrity of the page table control registers by comparing their current values to the previously checkpointed values at 440. It then validates that requestor 235 is a program that has previously registered with the registry. This is performed by comparing the location of the interrupting instruction in program 235 to the code location ranges specified in the registry. This yields the identity of the process, and it may then also be determined if the program is attempting to access its own critical memory regions, based on other information associated with that program in the registry.

Once the program 235 is validated, the SMM verification agent then requests the memory controller at 455 to relax access filters 270 to allow write access. It then uses the page tables to translate the virtual address passed at 425 to a physical address, at 450. Once the physical address has been obtained from the V2P mapper at 460, the data may be written to the critical region at 475. The memory controller filters are then reset to provide protection once more, at 465, and processing resumes in the program 235 after a successful return 470.

Many variations of the above described embodiment are possible. The processing described above takes place in an embodiment based on IA-32 concepts and functionality. However, other embodiments are possible in other architectures that have similar or equivalent functionality. In some embodiments more information about a registrant program may be stored in a registry, in others, less. For example, the process ID may or may not be stored. Many different data structures and algorithmic flows may be used in embodiments. Storage of the registers and registry in SMRAM may take a wide variety of forms as is known in the art. The actual processing in embodiments may differ accordingly. The terms “registry” and “registration” used in describing data stored relating to validated or registered processes in embodiments herein may not necessarily be used in other descriptions of other embodiments, instead, other more generic terms may be used such as “table,” “list,” “shortlist,” etc. for registry and “enlistment,” “enrollment,” etc. for registration without departing from the spirit and concept of the embodiments described herein. In some embodiments, the integrity check performed on the program may vary, or be omitted. In some embodiments, the memory access controller may not be present and only the remaining actions may be performed. The actions taken on finding an invalid program or an unregistered program may vary. In some embodiments, an error message, halt, or kernel panic may be generated. In others, a warning may be logged.

Some embodiments may include virtualization systems. Virtualization is a technique that enables a processor based host machine with support for virtualization in hardware and software, or in some cases, in software only, to present an abstraction of the host, such that the underlying hardware of the host machine appears as one or more independently operating virtual machines. Each virtual machine may therefore function as a self-contained platform. Often, virtualization technology is used to allow multiple guest operating systems and/or other guest software to coexist and execute apparently simultaneously and apparently independently on multiple virtual machines while actually physically executing on the same hardware platform. A virtual machine may mimic the hardware of the host machine or alternatively present a different hardware abstraction altogether.

Virtualization systems provide guest software operating in a virtual machine with a set of resources (e.g., processors, memory, IO devices) and may map some or all of the components of a physical host machine into the virtual machine, or create fully virtual components. The virtualization system may thus be said to provide a virtual bare machine interface to guest software. In some embodiments, virtualization systems may include a virtual machine monitor (VMM) which controls the host machine. The VMM provides guest software operating in a virtual machine (VM) with a set of resources such as processors, memory, and IO devices. The VMM may map some or all of the components of a physical host machine into the virtual machine, and may create fully virtual components, emulated in software in the VMM, which are included in the virtual machine (e.g., virtual IO devices). The VMM uses facilities in a hardware virtualization architecture to provide services to a virtual machine and to provide protection from and between multiple virtual machines executing on the host machine. Generally, the memory space in which the VMM operates is a part of host physical memory that is not accessible to any of the virtual machines that are serviced by the VMM.

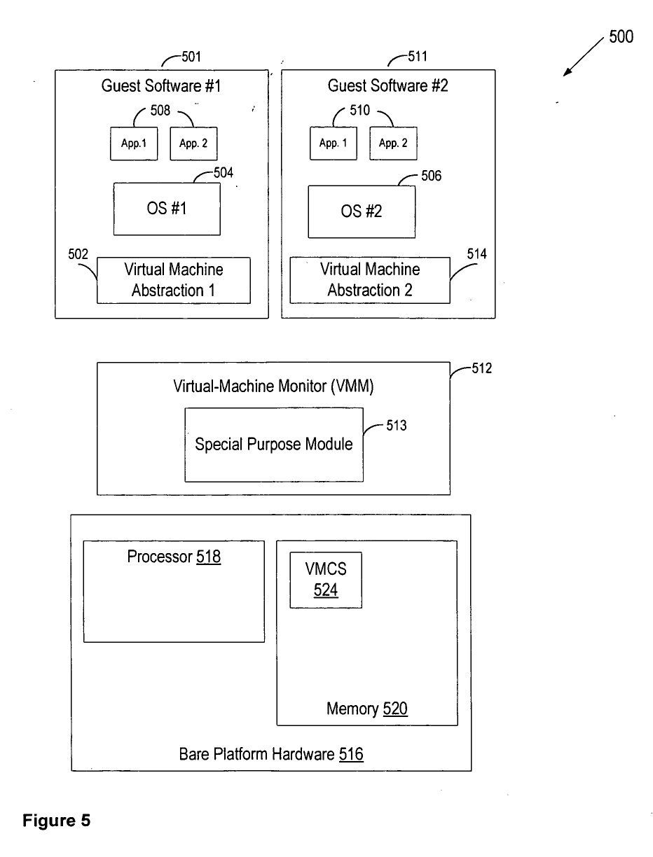

FIG. 5 illustrates one embodiment of a virtual-machine environment 500. In this embodiment, a processor-based platform 516 may execute a VMM 512. The VMM, though typically implemented in software, may emulate and export a virtual bare machine interface to higher level software. Such higher level software may comprise a standard OS, a real time OS, or may be a stripped-down environment with limited operating system functionality and may not include OS facilities typically available in a standard OS in some embodiments. Alternatively, for example, the VMM 512 may be run within, or using the services of, another VMM. VMMs may be implemented, for example, in hardware, software, firmware or by a combination of various techniques in some embodiments.

The platform hardware 516 may be a personal computer (PC), mainframe, handheld device such as a personal digital assistant (PDA) or “smart” mobile phone, portable computer, set top box, or another processor-based system. The platform hardware 516 includes at least a processor 518 and memory 520. Processor 518 may be any type of processor capable of executing programs, such as a microprocessor, digital signal processor, microcontroller, or the like. The processor may include microcode, programmable logic or hard coded logic for execution in embodiments. Although FIG. 5 shows only one such processor 518, there may be one or more processors in the system in an embodiment. Additionally, processor 518 may include multiple cores, support for multiple threads, or the like. Memory 520 can comprise a hard disk, a floppy disk, random access memory (RAM), read only memory (ROM), flash memory, any combination of the above devices, or any other type of machine medium readable by processor 518 in various embodiments. Memory 520 may store instructions and/or data for performing program execution and other method embodiments.

The VMM 512 presents to guest software an abstraction of one or more virtual machines, which may provide the same or different abstractions to the various guests. FIG. 5 shows two virtual machines, 502 and 514. Guest software such as guest software 501 and 511 running on each virtual machine may include a guest OS such as a guest OS 504 or 506 and various guest software applications 508 and 510. Guest software 501 and 511 may access physical resources (e.g., processor registers, memory and I/O devices) within the virtual machines on which the guest software 501 and 511 is running and to perform other functions. For example, the guest software 501 and 511 expects to have access to all registers, caches, structures, I/O devices, memory and the like, according to the architecture of the processor and platform presented in the virtual machine 502 and 514.

In one embodiment, the processor 518 controls the operation of the virtual machines 502 and 514 in accordance with data stored in a virtual machine control structure (VMCS) 524. The VMCS 524 is a structure that may contain state of guest software 501 and 511, state of the VMM 512, execution control information indicating how the VMM 512 wishes to control operation of guest software 501 and 511, information controlling transitions between the VMM 512 and a virtual machine, etc. The processor 518 reads information from the VMCS 524 to determine the execution environment of the virtual machine and to constrain its behavior. In one embodiment, the VMCS 524 is stored in memory 520. In some embodiments, multiple VMCS structures are used to support multiple virtual machines.

Resources that can be accessed by guest software (e.g., 501, including guest OS 504 and application 508) may either be classified as “privileged” or “non-privileged.” For privileged resources, the VMM 512 facilitates functionality desired by guest software while retaining ultimate control over these privileged resources. Further, each guest software 501 and 511 expects to handle various platform events such as exceptions (e.g., page faults, general protection faults, etc.), interrupts (e.g., hardware interrupts, software interrupts), and platform events (e.g., initialization (INIT) and system management interrupts (SMIs)). Some of these platform events are “privileged” because they must be handled by the VMM 512 to ensure proper operation of virtual machines 502 and 514 and for protection from and among guest software. Both guest operating system and guest applications may attempt to access privileged resources and both may cause or experience privileged events. Privileged platform events and access attempts to privileged resources are collectively referred to as “privileged events” or “virtualization events” herein.

In some embodiments a mode similar to the system management mode described above may be implemented as a special purpose module 513 within VMM 512. Just as the SMM may perform system management tasks for a host, the VMM may perform system management tasks for a virtual host or virtual machine such as 501. This is because, just as with the SMM, a special interrupt generated by a virtualization event in a guest such as 501 or 511 may invoke the VMM, which then operates in a region of memory that is inaccessible to the guest software executing in the VMs 502 and 514. Furthermore, the VMM has special access to the memory used by guest processes and may inspect and modify it. Just as in the SMM mode, the system state of a VM is saved on entry to the VMM or VMEXIT. While running the VMM, the processor may execute special handlers just as in the SMM mode, which reside in a portion of memory that is inaccessible to the guest processes running in the VMs. In a manner similar to the RSM instruction in the SMM mode, the VMENTER instruction causes a return to normal processing in the guest after the VMM has completed its operations.

Thus the embodiments described with reference to the SMM as in the descriptions of FIGS. 2, 3 and 4 above may be analogously alternatively implemented in a VMM. In one embodiment, the entirety of the functionality of SMM may alternatively be provided as part of the special module 513, and all of the actions described above occur in this alternative implementation of an SMM.

In other embodiments, only the functionality related to protecting the memory management system described above may be implemented within a VMM. Just as in the case of the SMM based implementation, a guest executing in a VM may register by creating a virtualization event, triggering a VMEXIT to activate an agent within the VMM, passing the same parameters as earlier described with reference to FIG. 3. As before, the agent may perform processing to register the guest, including validation of the guest, storing paging system registers, updating memory controller filters and then allow the guest to resume by executing a VMENTER, as previously described with reference to FIG. 3.

Furthermore, in a manner analogous to FIG. 4, a guest may trigger another virtualization event to request access to a protected region of memory, passing parameters as previously described with reference to the Figure. As described in FIG. 4 with reference to an SMI handler, the handler in the VMM may verify the integrity of the page table control registers. validate the requesting guest program against the registry, provide access to the critical regions of memory including performing V2P mapping, and return control to the guest after access is complete and the critical regions are protected again with a VMEXIT.

As before many variations of the embodiments based on a VMM are possible. The virtual machines shown in FIG. 5 are only one representation of one embodiment, in other embodiments, the actual number of virtual machines executing on a host machine may vary from one to many. Portions of the VMM and the VMCS may be implemented in hardware or in software to different extents in different embodiments. The basic functions provided by the VMM may vary in some embodiments. Each embodiment may define a different set of virtualization events. As previously indicated, the processing described above takes place in an embodiment based on IA-32 concepts and functionality. However, other embodiments are possible in other architectures that have similar or equivalent functionality. In some embodiments more information about a registrant program may be stored in a registry, in others, less. For example, the process ID may or may not be stored. Many different data structures and algorithmic flows may be used in embodiments. Storage of the registers and registry in VMM dedicated memory may take a wide variety of forms as is known in the art. The actual processing in embodiments may differ accordingly. The terms “registry” and “registration” used in describing data stored relating to validated or registered processes in embodiments herein may not necessarily be used in other descriptions of other embodiments, instead, other more generic terms may be used such as “table,” “list,” “shortlist,” etc. for registry and “enlistment,” “enrollment,” etc. for registration without departing from the spirit and concept of the embodiments described herein. In some embodiments, the integrity check performed on the program may vary, or be omitted. In some embodiments, the memory access controller may not be present and only the remaining actions may be performed. The actions taken on finding an invalid program or an unregistered program may vary. In some embodiments, an error message, halt, or kernel panic may be generated. In others, a warning may be logged.

In the preceding description, for purposes of explanation, numerous specific details are set forth in order to provide a thorough understanding of the described embodiments, however, one skilled in the art will appreciate that many other embodiments may be practiced without these specific details.

Some portions of the detailed description above is presented in terms of algorithms and symbolic representations of operations on data bits within a processor-based system. These algorithmic descriptions and representations are the means used by those skilled in the art to most effectively convey the substance of their work to others in the art. The operations are those requiring physical manipulations of physical quantities. These quantities may take the form of electrical, magnetic, optical or other physical signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the description, terms such as “executing” or “processing” or “computing” or “calculating” or “determining” or the like, may refer to the action and processes of a processor-based system, or similar electronic computing device, that manipulates and transforms data represented as physical quantities within the processor-based system's storage into other data similarly represented or other such information storage, transmission or display devices.

In the description of the embodiments, reference may be made to accompanying drawings. In the drawings, like numerals describe substantially similar components throughout the several views. Other embodiments may be utilized and structural, logical, and electrical changes may be made. Moreover, it is to be understood that the various embodiments, although different, are not necessarily mutually exclusive. For example, a particular feature, structure, or characteristic described in one embodiment may be included within other embodiments.

Further, a design of an embodiment that is implemented in a processor may go through various stages, from creation to simulation to fabrication. Data representing a design may represent the design in a number of manners. First, as is useful in simulations, the hardware may be represented using a hardware description language or another functional description language. Additionally, a circuit level model with logic and/or transistor gates may be produced at some stages of the design process. Furthermore, most designs, at some stage, reach a level of data representing the physical placement of various devices in the hardware model. In the case where conventional semiconductor fabrication techniques are used, data representing a hardware model may be the data specifying the presence or absence of various features on different mask layers for masks used to produce the integrated circuit. In any representation of the design, the data may be stored in any form of a machine-readable medium. An optical or electrical wave modulated or otherwise generated to transmit such information, a memory, or a magnetic or optical storage such as a disc may be the machine readable medium. Any of these mediums may “carry” or “indicate” the design or software information. When an electrical carrier wave indicating or carrying the code or design is transmitted, to the extent that copying, buffering, or re-transmission of the electrical signal is performed, a new copy is made. Thus, a communication provider or a network provider may make copies of an article (a carrier wave) that constitute or represent an embodiment.

Embodiments may be provided as a program product that may include a machine-readable medium having stored thereon data which when accessed by a machine may cause the machine to perform a process according to the claimed subject matter. The machine-readable medium may include, but is not limited to, floppy diskettes, optical disks, DVD-ROM disks, DVD-RAM disks, DVD-RW disks, DVD+RW disks, CD-R disks, CD-RW disks, CD-ROM disks, and magneto-optical disks, ROMs, RAMs, EPROMs, EEPROMs, magnet or optical cards, flash memory, or other type of media/machine-readable medium suitable for storing electronic instructions. Moreover, embodiments may also be downloaded as a program product, wherein the program may be transferred from a remote data source to a requesting device by way of data signals embodied in a carrier wave or other propagation medium via a communication link (e.g., a modem or network connection).

Many of the methods are described in their most basic form but steps can be added to or deleted from any of the methods and information can be added or subtracted from any of the described messages without departing from the basic scope of the claimed subject matter. It will be apparent to those skilled in the art that many further modifications and adaptations can be made. The particular embodiments are not provided to limit the claimed subject matter but to illustrate it. The scope of the claimed subject matter is not to be determined by the specific examples provided above but only by the claims below.

What is claimed is:

1. A method comprising:
registering a first program operable to access a first address of a first protected region of memory in a registry; and
in response to a second program making a request to access a second address of a second protected region of memory,
deciding whether the second program is registered in the registry; and
if the second program is registered,
translating the second address to a physical address;
checking the validity of a control register associated with a page table and if the control register is valid, modifying a restriction on access to a field in a page table associated with the second address.

2. The method of claim 1 wherein registering the first program further comprises:
recording the value of the page table control register associated with the page table;
protecting a first memory location of a field in the page table associated with the first address; and
storing a code location range for the first program registered with the registry;

3. The method of claim 2 where protecting the first memory location further comprises specifying an access restriction for the first memory location to a memory controller operable to provide the access restriction.

4. The method of claim 3 wherein specifying the access restriction further comprises specifying a read-only access restriction; and wherein modifying the restriction on access further comprises modifying the restriction to allow write access.

5. The method of claim 1 wherein:
the second program making a request to access the second address further comprises the second program executing an instruction; and
deciding whether the second program is registered in the registry further comprises comparing the location of the instruction with the code location range for each program registered with the registry.

6. The method of claim 1,
wherein registering the first program further comprises the first program generating a first system management interrupt (SMI);
wherein a system management agent, located in a system management memory inaccessible to the first program, to service the first SMI, performs processing comprising
recording the value of the page table control register associated with the page table;
protecting a first memory location of the field in the page table associated with the first address; and
storing a code location range for the first program registered with the registry; and
wherein the registry is stored in the system management memory

7. The method of claim 6 wherein protecting the first memory location further comprises the system management agent accessing a function of a memory controller of the system, the function further accessible exclusively in the system management mode of the system.

8. The method of claim 7 wherein making the request to access the second address further comprises generating a second SMI; and wherein a system management agent located in a system management memory inaccessible to the program, to service the second SMI, performs processing comprising:
servicing the second system management interrupt,
deciding whether the second program is registered;
translating the second address; and
modifying the access permission of the physical address.

9. The method of claim 1,
wherein the first program is a guest executing in a virtual machine;
wherein registering the first program further comprises the first program generating a first virtualization event;
wherein a first agent executing as part of a virtual machine monitor and located in a virtual machine monitor memory inaccessible to the first program, to service the first virtualization event, performs processing comprising
recording the value of the page table control register associated with the page table;
protecting a first memory location of the field in the page table associated with the first address; and
storing a code location range for the first program registered with the registry; and
wherein the registry is stored in the virtual machine monitor memory.

10. The method of claim 9 wherein protecting the first memory location further comprises the first agent accessing a function of a memory controller of the system, the function further accessible exclusively from the virtual machine monitor.

11. The method of claim 10 wherein:
making the request to access the second address further comprises generating a second virtualization event; and
a second agent executing as part of a virtual machine monitor and located in a virtual machine monitor memory inaccessible to the second program, performs processing comprising:
servicing the second virtualization event,
deciding whether the second program is registered;
translating the second address; and
modifying the access permission of the physical address.

12. The method of claim 1 wherein registering the first program in the registry further comprises validating the first program, and registering the first program only if it is valid.

13. The method of claim 12 wherein validating the first program further comprises comparing a hash of the program code of the first program with a predetermined value, and wherein the first program is valid if and only if the hash is equal to the predetermined value.

14. The method of claim 2 wherein checking the validity of the control register further comprises comparing the contents of the control register with the recorded value of the page table control register.

15. A machine readable medium having stored thereon data that when accessed by a machine causes the machine to perform a method, the method comprising:
registering a first program operable to access a first address of a first protected region of memory in a registry; and
in response to a second program making a request to access a second address of a second protected region of memory,
deciding whether the second program is registered in the registry;
if the second program is registered,
translating the second address to a physical address;
checking the validity of a control register associated with a page table and if the control register is valid, modifying a restriction on access to a field in a page table associated with the second address.

16. The machine readable medium of claim 15 wherein registering the first program further comprises:
recording the value of the page table control register associated with the page table;
protecting a first memory location of the field in the page table associated with the first address; and
storing a code location range for the first program registered with the registry;

17. The machine readable medium of claim 16 where protecting the first memory location further comprises specifying an access restriction for the first memory location to a memory controller operable to provide the access restriction.

18. The machine readable medium of claim 17 wherein specifying the access restriction further comprises specifying a read-only access restriction; and wherein relaxing the restriction on access further comprises modifying the restriction to allow write access.

19. The machine readable medium of claim 15 wherein:
the second program making a request to access the second address further comprises the second program executing an instruction; and
deciding whether the second program is registered in the registry further comprises comparing the location of the instruction with the code location range for each program registered with the registry.

20. The machine readable medium of claim 15 wherein:
registering the first program further comprises the first program generating a first system management interrupt (SMI);
a system management agent, located in a system management memory inaccessible to the first program, to service the first SMI, performs processing comprising
recording the value of the page table control register associated with the page table;
protecting a first memory location of the field in the page table associated with the first address; and
storing a code location range for the first program registered with the registry; and
the registry is stored in the system management memory

21. The machine readable medium of claim 15,
wherein the first program is a guest executing in a virtual machine;
wherein registering the first program further comprises the first program generating a first virtualization event;
wherein a first agent executing as part of a virtual machine monitor and located in a virtual machine monitor memory inaccessible to the first program, to service the first virtualization event, performs processing comprising
recording the value of the page table control register associated with the page table;
protecting a first memory location of the field in the page table associated with the first address; and
storing a code location range for the first program registered with the registry; and
wherein the registry is stored in the virtual machine monitor memory.

22. The machine readable medium of claim 15 wherein registering the first program in the registry further comprises validating the first program, and registering the first program only if it is valid.

23. The machine readable medium of claim 22 wherein validating the first program further comprises comparing a hash of the program code of the first program with a predetermined value, and wherein the first program is valid if and only if the hash is equal to the predetermined value.

24. The machine readable medium of claim 16 wherein checking the validity of the control register further comprises comparing the contents of the control register with the recorded value of the page table control register.

25. A system comprising:
a processor operable to execute an instruction specifying memory type;
a memory communicatively coupled to the processor, having stored therein a registry and a handler, the registry to register a first program operable to access a first address of a first protected region of memory in a registry; and
the handler operable to respond to a second program making a request to access a second address of a second protected region of memory,
to decide whether the second program is registered in the registry;
if the second program is registered,
to translate the second address to a physical address;
to check the validity of a control register associated with a page table and if the control register is valid, to modify a restriction on access to a field in a page table associated with the second address.

26. The system of claim 25 wherein the registry further comprises stored data identifying the program registered with the registry; the value of the page table control register associated with the page table; and a code location range of the registered program.

27. The system of claim 26 further comprising a register of the processor to store memory types and wherein the second program making a request to access the second address further comprises the second program executing an instruction; and
the handler is further to compare the location of the instruction with the code location range for each program registered with the registry.

28. The system of claim 27 wherein:
the second program making a request further comprises the second program generating a system management interrupt,
the handler comprises a system management agent; and
the memory comprises a system management memory.

29. The system of claim 27 wherein
the registered program is a guest executing in a virtual machine;
the second program making a request further comprises the second program generating a virtualization event;
the handler comprises a first agent executing as part of a virtual machine monitor; and
the memory comprises a virtual machine monitor memory inaccessible to the registered program.

30. The system of claim 27 wherein the memory is Dynamic Random Access Memory (DRAM).
